(19) United States
(12) Patent Application Publication
(10) Pub. No.: US 2008/0298199 A1
(43) Pub. Date: Dec. 4, 2008

(54) WRITING STRATEGY PARAMETERS INDEXING METHOD AND RECORDING APPARATUS THEREFOR

(75) Inventors: Hui Zhao, Suwon-si (KR); In-oh Hwang, Seongnam-si (KR); Hyun-soo Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/132,655

(22) Filed: Jun. 4, 2008

(30) Foreign Application Priority Data
Jun. 4, 2007 (KR) 2007-54623

(51) Int. Cl. G11B 7/0045

(52) U.S. Cl. 369/59.12

(57) ABSTRACT

A writing strategy parameters indexing method and a recording apparatus therefor. The writing strategy parameters indexing method includes operations of receiving an NRZ sequence; moving the NRZ sequence by as much as a bit with respect to a channel block using a slide-window having a length of N bits; determining whether a bit pattern of the NRZ sequence in the window-slide has a predetermined bit pattern; extracting writing strategy parameters corresponding to the predetermined bit pattern when the bit pattern of the NRZ sequence in the window-slide has the predetermined pattern; and generating recording pulses using the writing strategy parameters.

### CROSS-REFERENCE TO RELATED APPLICATIONS

This application claims the benefit of Korean Patent Application No. 2007-54623, filed in the Korean Intellectual Property Office on Jun. 4, 2007, the disclosure of which is incorporated herein by reference.

### BACKGROUND OF THE INVENTION

1. Field of the Invention

Aspects of the present invention relate to a writing strategy parameters indexing method, and a writing strategy parameters adaptation method and an apparatus therefor, which are used to record high density optical data.

2. Description of the Related Art

A writing strategy is an important technique for recording data in an optical medium by alternately arranging marks and spaces that are modulated by an input Non Return to Zero (NRZ) sequence. The marks and spaces alternately recorded in the optical medium can be reproduced and reconstructed as the original input data during a read process.

In order to record the marks in a recording medium, a laser diode of an optical pickup device is driven so as to irradiate one or a sequence of laser pulses (or recording pulses). In an area of the recording medium where the sequence of laser pulses is irradiated, the marks are formed via a thermal process. A sequence of the recording pulses for forming the marks is selected by the writing strategy. The writing strategy can be adjusted so as to form a mark having an exact size in a medium or to enable data from the marks to be reproduced with a high reproduction quality.

FIG. 1 illustrates a principle of a conventional writing strategy. The principle of a widely used first writing strategy is shown in FIG. 1. Referring to FIG. 1, P1 is a mark having a length M1 which is to be recorded in a medium. A sequence of recording pulses is used to record the mark.

In a sequence of laser pulses, four parameters are generally adjusted according to the conventional writing strategy so that differentiated marks can be formed. The four parameters are a height H1 of a first pulse, a start time T1 of the first pulse, a height H2 of a last pulse, and an end time T2 of the last pulse. Due to a thermal propagation effect, a front edge of the mark is affected by a length S1 of a previous space; thus, the conventional writing strategy adjusts values of the height H1 and the start time T1 according to the mark length M1 and the previous space length S1. Also, due to a thermal propagation effect, the conventional writing strategy adjusts values of the height H2 and the end time T2 according to the mark length M1 and a next space length S2. Since such a conventional writing strategy is based on symbols, this conventional writing strategy is called ‘a symbol-based writing strategy’.

FIG. 2 is a table illustrating a principle of a conventional symbol-based writing strategy parameters indexing method. As illustrated in FIG. 2, a writing strategy parameter value of a start time T1 is indexed by a recorded mark length M (shown along the left side of the table) and a previous space length S (shown along the top of the table) in a lookup table. In this manner, a height H1, a height H2, and an end time T2 can be indexed according to lengths of two symbols (that is, the recorded mark length M and the previous space length S). This is the conventional symbol-based writing strategy parameters indexing method. In high density recording, marks or spaces having a short run-length can be close to a reproduction limitation of an optical device. In this case, inter symbol interference (ISI) increases. Therefore, a writing strategy has to include a new function for supporting a mark/space level with a short length.

A second writing strategy has been developed so as to adjust the writing strategy according to edge-shift errors of Partial Response Maximum Likelihood (PRML). However, in high density recording, shift errors with short run-lengths are dominant. Also, writing strategy parameters indexed by symbols determine various writing strategy window sizes according to varied lengths of the symbols. If parameters are indexed by two continuous short run-length signals, a window is not large enough to obtain sufficient information by which the conventional writing strategy processes the aggravated ISI and an aggravated thermal propagation. Therefore, the conventional symbol-based writing strategy parameters indexing method is not appropriate for a writing strategy for high density recording.

### SUMMARY OF THE INVENTION

Aspects of the present invention provide a writing strategy parameters indexing method and a recording apparatus therefor, which allocate writing strategy parameters to recordable bits and which generate recording pulses using the writing strategy parameters.

Aspects of the present invention also provide a channel technology for error feedback and for adapting the writing strategy parameters.

According to an aspect of the present invention, a writing strategy parameters indexing method performed in a recording apparatus is provided. The writing strategy parameters indexing method includes the operations of receiving an NRZ (Non Return to Zero) sequence; moving the NRZ sequence by as much as a bit with respect to a channel block using a slide-window having a length of N bits; determining whether a bit pattern of the NRZ sequence in the window-slide has a predetermined bit pattern; extracting writing strategy parameters corresponding to the predetermined bit pattern when the bit pattern of the NRZ sequence in the window-slide has the predetermined pattern; and generating recording pulses using the writing strategy parameters.

According to another aspect of the present invention, the writing strategy parameters include at least one of a start time of the recording pulses, an end time of the recording pulses, and a level of the recording pulses.

According to another aspect of the present invention, the determining of whether the bit pattern of the NRZ sequence in the window-slide has the predetermined bit pattern includes using a bit value at a predetermined location of the NRZ sequence in the slide-window.

According to another aspect of the present invention, the slide-window has a bit length of 2K+1, where K is a natural number, and the determining may include determining whether a bit value of a K+1th bit from among bits of the NRZ sequence in the slide-window is 1.

According to another aspect of the present invention, the determining of whether the bit pattern of the NRZ sequence in the window-slide has the predetermined bit pattern includes using at least one bit pattern from among a previous bit of a bit at the predetermined location in the slide-window and a next bit of the bit at the predetermined location in the slide-window.

According to another aspect of the present invention, the extracting of the writing strategy parameters includes searching for a bit pattern identical to the predetermined bit pattern in a parameters indexing table pre-stored in the recording apparatus when the predetermined bit value of the NRZ sequence is 1; and extracting the writing strategy parameters which are indexed with respect to the searched for bit pattern, using the parameters indexing table.

According to another aspect of the present invention, the writing strategy parameters indexing method further includes not generating the recording pulses when the bit pattern does not have the predetermined bit pattern.

According to another aspect of the present invention, a recording apparatus for performing a writing strategy parameters indexing method is provided. The recording apparatus includes a control unit to control the recording apparatus to move a received NRZ sequence by as much as a bit with respect to a channel block using a slide-window having a length of N bits, to determine whether a bit pattern of the NRZ sequence in the window-slide has a predetermined bit pattern, to extract writing strategy parameters corresponding to the predetermined bit pattern when the bit pattern of the NRZ sequence in the window-slide has the predetermined pattern, and to generate recording pulses using the writing strategy parameters; and a record unit to generate the recording pulses according to control by the control unit.

According to another aspect of the present invention, a computer readable recording medium is provided, having recorded thereon a program to execute a writing strategy parameters indexing method. The method includes receiving an NRZ sequence; moving the NRZ sequence by as much as a bit with respect to a channel block using a slide-window having a length of N bits; determining whether a bit pattern of the NRZ sequence in the window-slide has a predetermined bit pattern; extracting writing strategy parameters corresponding to the predetermined bit pattern when the bit pattern of the NRZ sequence in the window-slide has the predetermined pattern; and generating recording pulses by using the writing strategy parameters.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a principle of a conventional writing strategy;

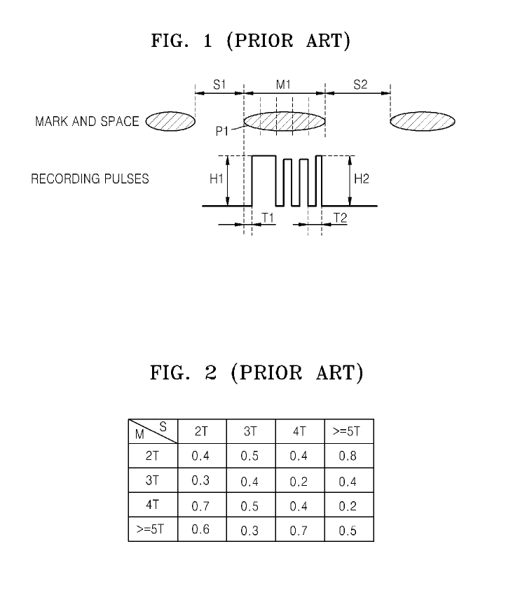

FIG. 2 is a table illustrating a principle of a conventional symbol-based writing strategy parameters indexing method;

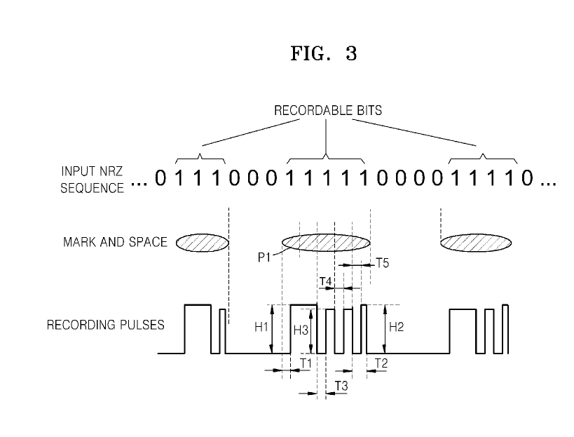

FIG. 3 illustrates a principle of a bit-based writing strategy according to an embodiment of the present invention;

FIG. 4 is a table of a bit writing strategy parameters indexing method according to a first embodiment of the present invention;

FIG. 5 illustrates a process of generating recording pulses, based on the bit-based writing strategy according to an embodiment of the present invention;

FIGS. 6A through 6D illustrate processes of a writing strategy based on the bit-based writing strategy according to the first embodiment of present invention;

FIGS. 7A and 7B illustrate fluctuations of a radio frequency (RF) signal level;

FIG. 8 illustrates a principle of a bit-based writing strategy adaptation method for minimization of the fluctuations of the RF signal level according to an embodiment of the present invention;

FIG. 9 is a block diagram of a structure of a writing strategy adaptation circuit according to a second embodiment of the present invention;

FIG. 10 is a block diagram of a structure of a writing strategy adaptation circuit to which a Finite Impulse Response (FIR) filter is applied according to a third embodiment of the present invention;

FIG. 11 is a block diagram of a simplified structure of a writing strategy adaptation circuit according to a fourth embodiment of the present invention;

FIG. 12 is a block diagram of a PLL circuit adopting a signal waveform phase detector as a frequency pull-in function according to a fifth embodiment of the present invention; and

FIG. 13 is a table illustrating a principle of a simplified bit-based writing strategy parameters indexing method according to a sixth embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

### First Embodiment

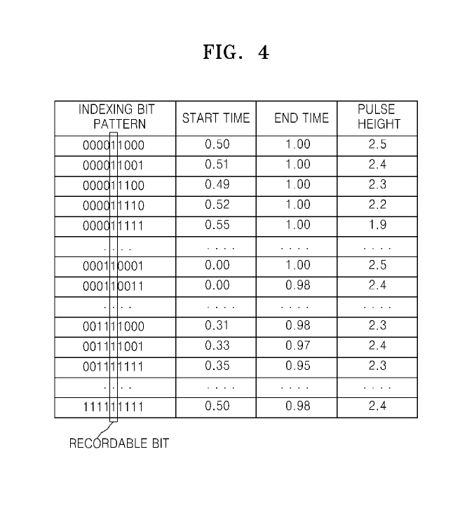

FIG. 3 shows a principle of a bit-based writing strategy according to a first embodiment of the present invention. The first embodiment of the present invention corresponds to the principle of the bit-based writing strategy.

FIG. 3 shows a relationship between an input Non Return to Zero (NRZ) sequence, recording marks and recording pulses. All marks correspond to 1s in the input NRZ sequence, and all of the recording marks correspond to all the marks. Thus, all of the is in the input NRZ sequence correspond to some recording pulses. The 1s in the input NRZ sequence are called recordable bits.

The bit-based writing strategy is used to control parameters of the recording pulses. Aspects of the present invention allocate writing strategy parameters to each of the recordable bits. As shown in FIG. 3, a mark P1 is a 5T mark having 5 of the recordable bits. Each of the 5 recordable bits is determined based on three writing strategy parameters, which are a start time of the recording pulses, an end time of the recording pulses, and a height of the recording pulses. According to other aspects of the invention, only one or two of the above writing strategy parameters may be employed.

FIG. 3 corresponds to an example of an assignment of the parameters. In a first recordable bit, the start time of the recording pulses is T1 (a unit: a channel clock), the end time of the recording pulses is 1 (a unit: a channel clock), and the height of the recording pulses is H1. In a second recordable bit, the start time of the recording pulses is 0 (a unit: a channel clock), the end time of the recording pulses is 1 (a unit: a channel clock), and the height of the recording pulses is H1. In a third recordable bit, the start time of the recording pulses is T3 (a unit: a channel clock), the end time of the recording pulses is 1 (a unit: a channel clock), and the height of the recording pulses is H3. In a fourth recordable bit, the start time of the recording pulses is T4 (a unit: a channel clock), the end time of the recording pulses is 1 (a unit: a channel clock), and the height of the recording pulses is H3. In a fifth recordable bit, the start time of the recording pulses is T5 (a unit: a channel clock), the end time of the recording pulses is T2 (a unit: a channel clock), and the height of the recording pulses is H2.

The first recordable bit is a type 1 recordable bit that is a first recordable bit of a mark. The fifth recordable bit is a type 2 recordable bit that is a last recordable bit of the mark. The second, third, and fourth recordable bits are type 3 recordable bits which are neither the first recordable bit of the mark nor the last recordable bit of the mark.

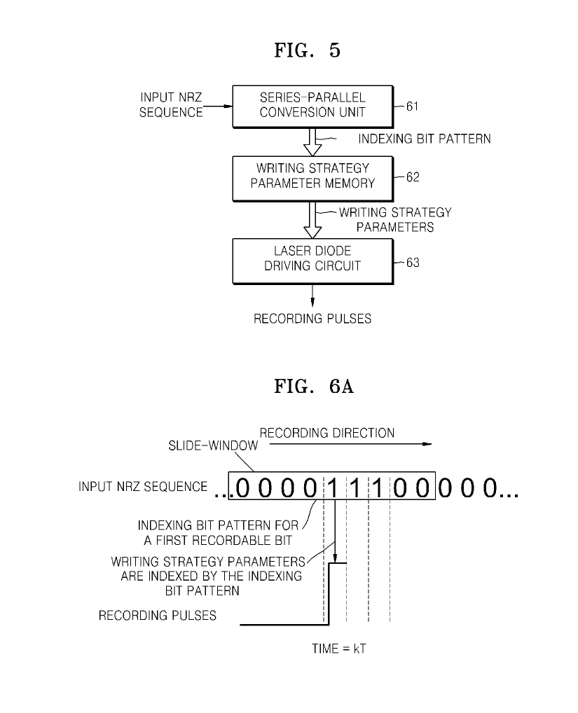

FIG. 4 is a table of a bit writing strategy parameters indexing method according to the first embodiment of the present invention. In the table, an indexing bit pattern in a column along the left side lists all recordable bit patterns having a width of 9. A middle bit of each of the recordable bit patterns having the width of 9 should be a recordable bit.

Each indexing bit pattern is used to index three items of writing strategy parameters of the recordable bit. The writing strategy parameters are indexed with respect to the recordable bit such that the recordable bit, four previous bits of the recordable bit, and four next bits of the recordable bit form an indexing pattern.

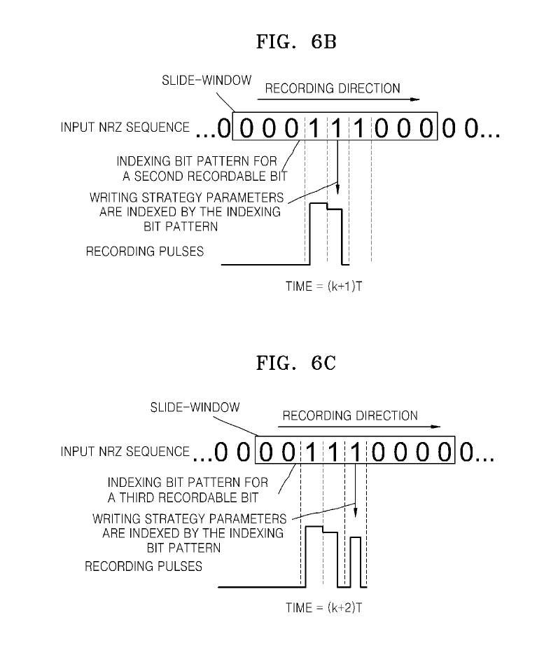

FIG. 5 shows a process of generating recording pulses, based on the bit-based writing strategy according to an embodiment of the present invention. FIG. 5 shows how the bit writing strategy parameters indexing method is used in a recording process. A series-parallel conversion unit 61 receives an input NRZ sequence. With respect to each channel clock, the series-parallel conversion unit 61 outputs 9 finally received bits in a parallel form, as an indexing bit pattern.

An element 62 indicates a writing strategy parameters memory. Memory contents of the writing strategy parameters memory 62 are the same as the table of FIG. 4. The indexing bit pattern is used to allocate addresses to the contents. The addresses respectively correspond to the start time of the recording pulses, the end time of the recording pulses, and the height of the recording pulses. The indexing bit pattern output by the series-parallel conversion unit 61 is a valid writing strategy indexing bit pattern. That is, the middle bit is a recordable bit. The writing strategy parameter memory 62 outputs corresponding writing strategy parameters that are indexed by the indexing bit pattern.

The writing strategy parameters are transmitted to a laser diode driving circuit 63. The laser diode driving circuit 63 generates recording pulses that are defined by the transmitted writing strategy parameters.

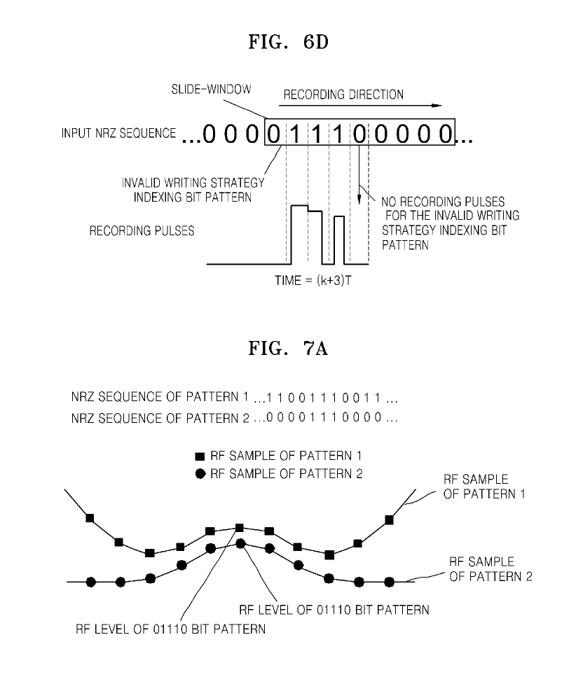

FIGS. 6A through 6D show processes of the writing strategy based on the bit-based writing strategy according to the first embodiment of present invention. The input NRZ sequence is to be recorded in a medium. The input NRZ sequence is observed by a slide-window having a width of 9.

In FIG. 6A, at a time kT, a bit pattern in the slide-window is a valid writing strategy indexing bit pattern. The valid writing strategy indexing bit pattern is used to index the writing strategy parameters, which are the start time of recording pulses, the end time of the recording pulses, and the height of the recording pulses, when the first recordable bit of the mark is recorded. The recording pulses are generated according to the indexed writing strategy parameters.

In FIG. 6B, at a time (k+1)T, the slide-window slides by as much as a bit, according to a recording direction. A bit pattern in the slide-window is a valid writing strategy indexing bit pattern which is used to index the writing strategy parameters (the start time of recording pulses, the end time of the recording pulses, and the height of the recording pulses) when the second recordable bit of the mark is recorded. The recording pulses are generated according to the indexed writing strategy parameters.

In FIG. 6C, at a time (k+2)T, the slide-window slides by as much as a bit, according to the recording direction. A bit pattern in the slide-window is a valid writing strategy indexing bit pattern which is used to index the writing strategy parameters (the start time of recording pulses, the end time of the recording pulses, and the height of the recording pulses) when the third recordable bit of the mark is recorded. The recording pulses are generated according to the indexed writing strategy parameters.

In FIG. 6D, at a time (k+3)T, the slide-window slides by as much as a bit, according to the recording direction. A bit pattern in the slide-window is an invalid writing strategy indexing bit pattern. The recording pulses are thus not generated.

### Second Embodiment

The second embodiment of the present invention is a bit-based writing strategy adaptation method. The bit writing strategy parameters indexing method related to the second embodiment of the present invention is previously described with reference to the first embodiment.

The bit-based writing strategy adaptation method of the second embodiment uses a Viterbi detector having a detection window having a width of 5. The Viterbi detector is used to detect an NRZ sequence according to Partial Response Maximum Likelihood (PRML) technology during a read process. An actual radio frequency (RF) signal is compared to a reference level for detection. However, the actual RF signal is not matched well with the reference level due to noise and inter symbol interference (ISI).

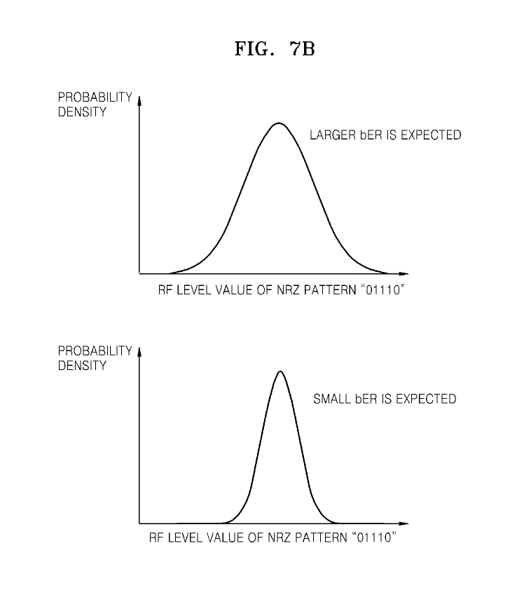

FIGS. 7A and 7B show fluctuations of an RF signal level. FIG. 7A illustrates the fluctuations of the RF signal level due to the ISI. An RF signal level of an NRZ pattern “01110” in an NRZ sequence “ . . . 00001110000 . . . ” is different from an RF signal level of a same NRZ pattern “01110” in an NRZ sequence “ . . . 11001110011 . . . ”, due to previous bits and next bits of each of the NRZ sequences.

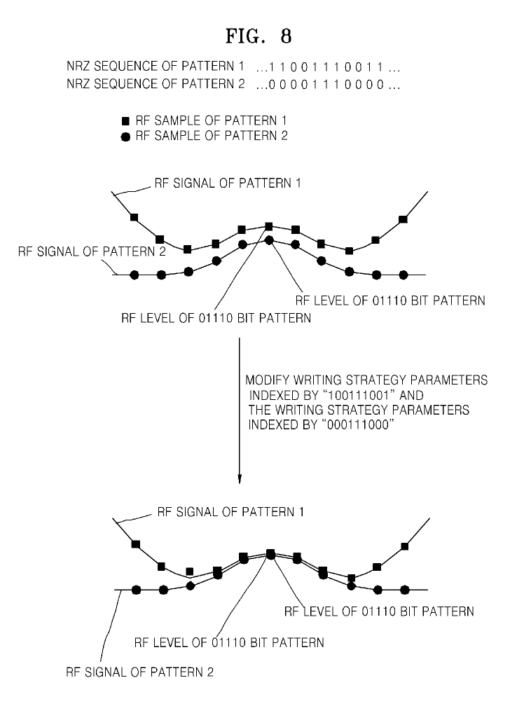

FIG. 7B shows statistical distributions of the RF signal level of the NRZ pattern “01110”. The wider the distributions, the greater the bER (bit error ratio). An objective of the bit-based writing strategy adaptation method is to minimize a variance of an RF level due to the ISI. This is shown in FIG. 8.

FIG. 8 shows a principle of the bit-based writing strategy adaptation method for the minimization of the fluctuations of the RF signal level according to an embodiment of the present invention. When an RF signal is read and detected, an RF level error of an NRZ pattern “01110” is evaluated. Two writing strategy parameters, which are indexed by each of “100111001” and “000111000”, are modified so as to compensate for the RF level error. Thus, the variance of the RF level due to the ISI may be reduced according to well designed writing strategy parameters.

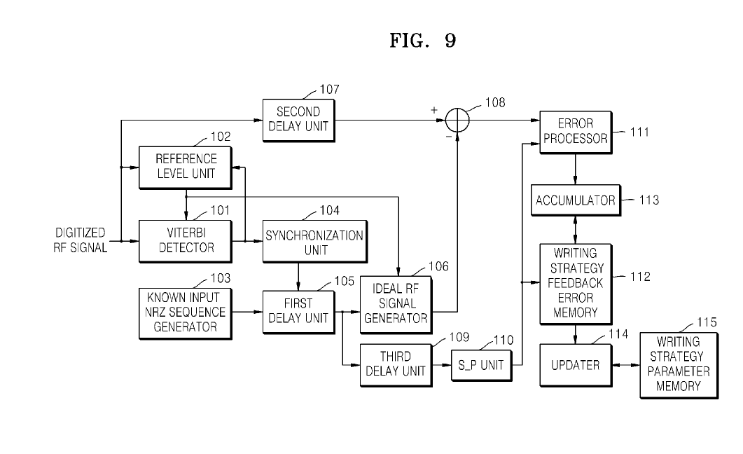

FIG. 9 shows a structure of a writing strategy adaptation circuit according to the second embodiment of the present invention. The writing strategy adaptation circuit according to the second embodiment is used to read data from a medium in which a known input NRZ sequence is recorded. A digitized RF signal, which has been reproduced, is transmitted to a Viterbi detector 101 having a detection window width of 5. The Viterbi detector 101 outputs a detected NRZ sequence. A reference level unit 102 stores and adjusts an RF signal level according to an input, that is, the digitized RF signal and the detected NRZ sequence. A reference level is input to the Viterbi detector 101 to detect an adaptive PRML.

A known input NRZ sequence generator 103 continuously outputs the known input NRZ sequence on a bit by bit basis in each channel clock. A synchronization unit 104 detects a synchronization pattern from the detected NRZ sequence. According to a location of the synchronization pattern, the synchronization unit 104 calculates a delay between the detected NRZ sequence and the known input NRZ sequence. The calculated number of delayed clocks is transferred to a first delay unit 105. The first delay unit 105 delays the known input NRZ sequence so as to synchronize the detected NRZ sequence with the known input NRZ sequence.

An ideal RF signal generator 106 generates an ideal RF signal according to the synchronized known input NRZ sequence from the first delay unit 105, and a reference level from the reference level unit 102. A second delay unit 107 delays the digitized RF signal. The number of delayed clocks is predetermined to be the digitized RF signal that is synchronized with the ideal RF signal output from the ideal RF signal generator 106. A subtraction unit 108 subtracts the ideal RF signal from the delayed digitized RF signal.

A third delay unit 108 delays the synchronized known input NRZ sequence by as much as the predetermined number of delayed clocks, thereby compensating for a time offset between an output from the subtraction unit 108 and the synchronized known input NRZ sequence.

A series-parallel conversion unit 110 (denoted as ‘an S_P unit 110’ in FIG. 9) converts 9 finally received bits into a parallel mode. An error processor 111 generates a feedback error by processing the output from the subtraction unit 108 and an output from the series-parallel conversion unit 110.

A writing strategy feedback error memory 112 stores accumulated feedback errors. Each of at least one cell in the writing strategy feedback error memory 112 stores the accumulated feedback errors. The cells are addressed according to the output from the series-parallel conversion unit 110. When the output from the series-parallel conversion unit 110 is a valid writing strategy indexing bit pattern, an output from the error processor 111 is accumulated, as contents of a corresponding cell, by an accumulator 113.

After an RF signal is reproduced during a predetermined time period, the feedback errors are accumulated in the writing strategy feedback error memory 112. Then, an updater 114 modifies a writing strategy parameter memory 115 according to contents of the writing strategy feedback error memory 112, so as to minimize a level error. The writing strategy parameter memory 115 has a structure similar to the table of FIG. 4. Each cell of the writing strategy parameter memory 115 stores three writing strategy parameters: a start time of recording pulses, an end time of the recording pulses, and a height of the recording pulses. After that, the writing strategy parameter memory 115 is updated and available for a recording process.

### Third Embodiment

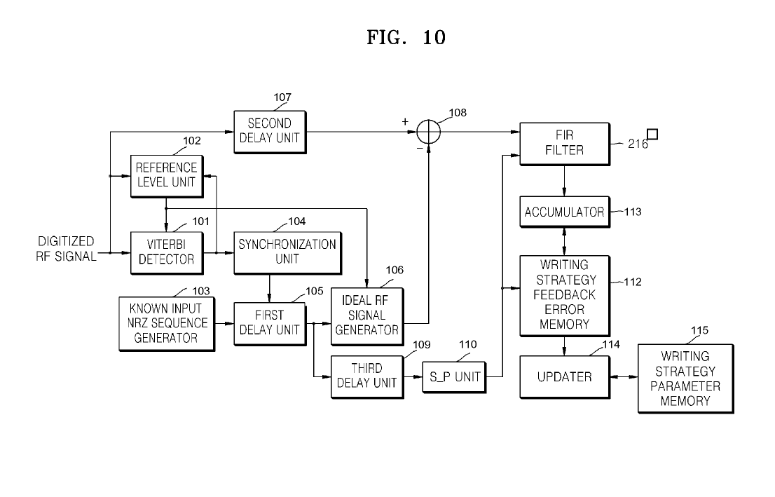

FIG. 10 shows a structure of a writing strategy adaptation circuit to which a Finite Impulse Response (FIR) filter is applied according to a third embodiment of the present invention. The third embodiment is similar to the second embodiment, except that the error processor 111 is replaced by an FIR filter 216 as shown in FIG. 10. Except for the FIR filter 216, other components perform the same functions with the components of FIG. 9. Thus, descriptions of the same components will be omitted here.

The FIR filter 216 has three groups of predetermined coefficients. When an output from the series-parallel conversion unit 110 is a type 1 indexing bit pattern, coefficients in the group 1 are applied. When the output from the series-parallel conversion unit 110 is a type 2 indexing bit pattern, coefficients in the group 2 are applied. When the output from the series-parallel conversion unit 110 is a type 3 indexing bit pattern, coefficients in the group 3 are applied. When the output from the series-parallel conversion unit 110 is an invalid indexing bit pattern, the FIR filter 216 stops its operation during a channel clock signal.

### Fourth Embodiment

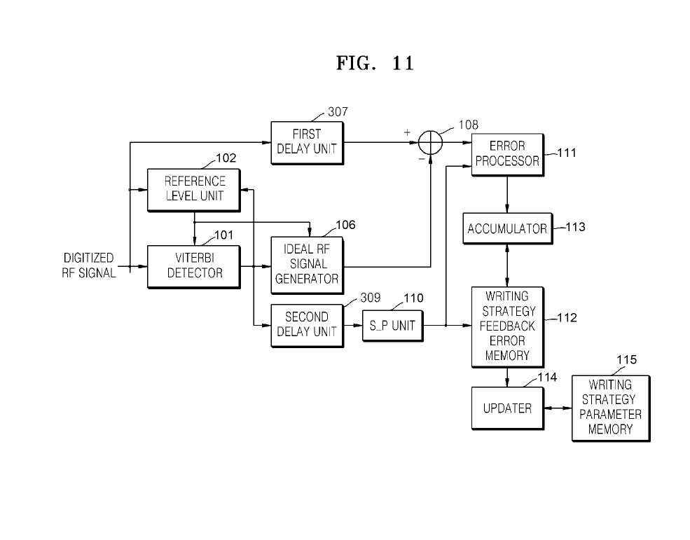

FIG. 11 shows a simplified structure of a writing strategy adaptation circuit according to the fourth embodiment of the present invention. As shown in FIG. 11, the fourth embodiment is similar to the second embodiment, except that a known NRZ sequence is replaced by a detected NRZ sequence. By doing so, the known input NRZ sequence generator 103, the synchronization unit 104, and the first delay unit 105 become unnecessary, and thus the circuit is simplified.

### Fifth Embodiment

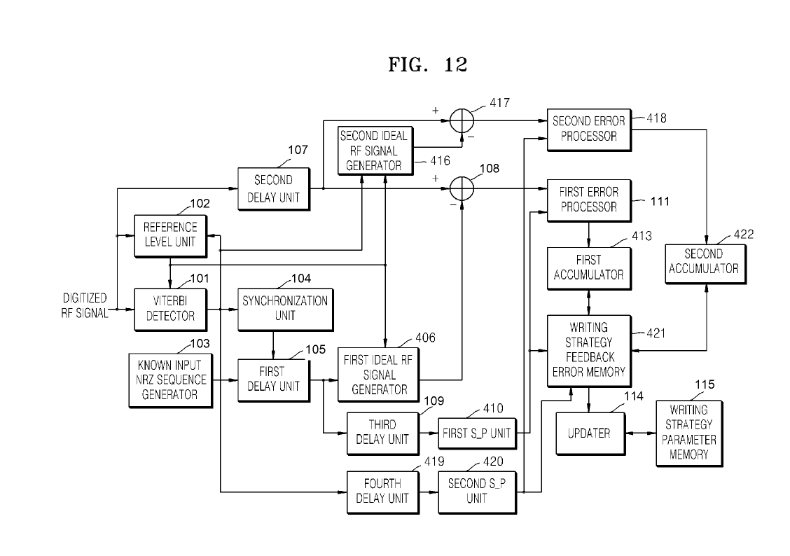

FIG. 12 shows a PLL circuit adopting a signal waveform phase detector as a frequency pull-in function according to a fifth embodiment of the present invention. As shown in FIG. 12, the fifth embodiment is similar to the second embodiment, except that both a known NRZ sequence and a detected NRZ sequence are used to calculate a feedback error.

A second ideal RF signal generator 416 is similar to a first ideal RF signal generator 406. A second subtraction unit 417 is similar to a first subtraction unit 408. A second error processor 418 is similar to the first error processor 111, and is added to the diagram of FIG. 7B so as to calculate the feedback error from the detected NRZ sequence.

A fourth delay unit 419 is identical to a third delay unit 409. A second series-parallel conversion unit 420 is identical to a first series-parallel conversion unit 410, and is added to the diagram of FIG. 7B so as to generate an indexing pattern. The writing strategy feedback error memory 112 of the second embodiment is replaced by a writing strategy feedback error memory 421 which has two interfaces that are indexed by an output from each of the first series-parallel conversion unit 410 and the second series-parallel conversion unit 420.

A second accumulator 422 is added so as to accumulate a feedback error from the second error processor 418. The output from the first series-parallel conversion unit 410 is associated with a first accumulator 413, so that the feedback error calculated from the known input NRZ sequence is accumulated. The output from the second series-parallel conversion unit 420 is associated with a second accumulator 422, so that the feedback error calculated from the detected NRZ sequence is accumulated.

### Sixth Embodiment

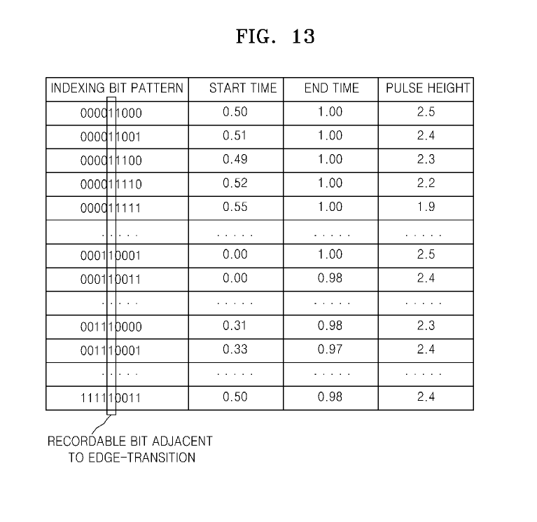

FIG. 13 shows a principle of a simplified bit-based writing strategy parameters indexing method according to the sixth embodiment of the present invention. The sixth embodiment is similar to the bit-based writing strategy parameters indexing method of the first embodiment, except that a valid writing strategy indexing bit pattern of the sixth embodiment does not include a pattern having the type 3 recordable bit in a middle of the pattern. Only the type 1 recordable bit and the type 2 recordable bit are included in the middle of the pattern, as a writing strategy indexing pattern. That is, an adaptive writing strategy may only adapt writing parameters of the type 1 and 2 recordable bits. The type 3 recordable bit has fixed writing strategy parameters. The sixth embodiment may reduce a complexity of the writing strategy.

Aspects of the present invention have several advantages. The bit-based writing strategy parameters indexing method adopts a fixed width of a writing strategy decision window, wherein the fixed width is appropriate for controlling the ISI. The writing strategy adaptation method based on the bit-based writing strategy indexing method is suitable for controlling the fluctuations of the RF level, compared to the conventional technology. The writing strategy adaptation method based on the bit-based writing strategy indexing method obtains feedback errors from a normal read process without having to determine an attribute of the medium.

As a result, the adaptive writing strategy may be more easily achieved, compared to the conventional technology. The proposed indexing method may be expressed in NRZ coding, and may also be expressed in a Non Return to Zero Inverted (NRZI) coding scheme. This change does not affect a basic idea of the present invention.

In addition, aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CDs, DVDs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A writing strategy parameters indexing method performed in a recording apparatus, the writing strategy parameters indexing method comprising:
receiving an NRZ (Non Return to Zero) sequence;
moving the NRZ sequence by as much as a bit with respect to a channel block using a slide-window having a length of N bits;
determining whether a bit pattern of the NRZ sequence in the window-slide has a predetermined bit pattern;
extracting writing strategy parameters corresponding to the predetermined bit pattern when the bit pattern of the NRZ sequence in the window-slide has the predetermined bit pattern; and
generating recording pulses using the writing strategy parameters.

2. The writing strategy parameters indexing method of claim 1, wherein the writing strategy parameters comprise at least one of a start time of the recording pulses, an end time of the recording pulses, and a level of the recording pulses.

3. The writing strategy parameters indexing method of claim 1, wherein the determining of whether the bit pattern of the NRZ sequence in the window-slide has the predetermined bit pattern comprises using a bit value at a predetermined location of the NRZ sequence in the slide-window.

4. The writing strategy parameters indexing method of claim 3, wherein:
the slide-window has a bit length of 2K+1, where K is a natural number; and
the determining comprises determining whether a bit value of a K+1th bit from among bits of the NRZ sequence in the slide-window is 1.

5. The writing strategy parameters indexing method of claim 3, wherein the determining of whether the bit pattern of the NRZ sequence in the window-slide has the predetermined bit pattern comprises using at least one bit pattern from among a previous bit of a bit at the predetermined location in the slide-window and a next bit of the bit at the predetermined location in the slide-window.

6. The writing strategy parameters indexing method of claim 3, wherein the extracting of the writing strategy parameters comprises:
searching for a bit pattern identical to the predetermined bit pattern in a parameters indexing table pre-stored in the recording apparatus when the predetermined bit value of the NRZ sequence is 1; and
extracting the writing strategy parameters which are indexed with respect to the searched for bit pattern, using the parameters indexing table.

7. The writing strategy parameters indexing method of claim 1, further comprising not generating the recording pulses when the bit pattern does not have the predetermined bit pattern.

8. A recording apparatus to perform a writing strategy parameters indexing method, the recording apparatus comprising:
a control unit to control the recording apparatus to move a received NRZ sequence by as much as a bit with respect to a channel block using a slide-window having a length of N bits, to determine whether a bit pattern of the NRZ sequence in the window-slide has a predetermined bit pattern, to extract writing strategy parameters corresponding to the predetermined bit pattern when the bit pattern of the NRZ sequence in the window-slide has the predetermined bit pattern, and to generate recording pulses using the writing strategy parameters; and
a record unit to generate the recording pulses according to control of the control unit.

9. The recording apparatus of claim 8, wherein the writing strategy parameters comprise at least one of a start time of the recording pulses, an end time of the recording pulses, and a level of the recording pulses.

10. The recording apparatus of claim 8, wherein the control unit determines whether the bit pattern of the NRZ sequence in the window-slide has the predetermined bit pattern, using a bit value at a predetermined location of the NRZ sequence in the slide-window.

11. The recording apparatus of claim 10, wherein:
the slide-window has a bit length of 2K+1, where K is a natural number, and the control unit determines whether a bit value of a K+1th bit from among bits of the NRZ sequence in the slide-window is 1, thereby determining whether the bit pattern of the NRZ sequence in the window-slide has the predetermined bit pattern.

12. The recording apparatus of claim 10, wherein the control unit determines whether the bit pattern of the NRZ sequence in the window-slide has the predetermined bit pattern, using at least one bit pattern from among a previous bit of a bit at the predetermined location in the slide-window and a next bit of the bit at the predetermined location in the slide-window.

13. The recording apparatus of claim 10, wherein the control unit searches for a bit pattern identical to the predetermined bit pattern in a parameters indexing table pre-stored in the recording apparatus when the predetermined bit value of the NRZ sequence is 1, and extracts the writing strategy parameters which are indexed with respect to the searched for bit pattern, using the parameters indexing table.

14. The recording apparatus of claim 8, wherein the control unit controls the recording apparatus not to generate the recording pulses when the bit pattern does not have the predetermined bit pattern.

15. A computer readable recording medium having recorded thereon a program to execute a writing strategy parameters indexing method, the method comprising:
receiving an NRZ sequence;
moving the NRZ sequence by as much as a bit with respect to a channel block using a slide-window having a length of N bits;
determining whether a bit pattern of the NRZ sequence in the window-slide has a predetermined bit pattern;
extracting writing strategy parameters corresponding to the predetermined bit pattern when the bit pattern of the NRZ sequence in the window-slide has the predetermined bit pattern; and
generating recording pulses by using the writing strategy parameters.

16. A recording apparatus comprising:
a Viterbi detector to detect and output a non-return to zero (NRZ) sequence based on a digitized radio frequency (RF) signal and a reference level;
a reference level unit to output the reference level to the Viterbi detector based on the digitized RF signal and the detected NRZ sequence;
a synchronization unit to detect a synchronization pattern from the detected NRZ sequence and to calculate a delay between the detected NRZ sequence and a known NRZ sequence;
a first delay unit to delay the known NRZ sequence based on the calculated delay so as to synchronize the known NRZ sequence with the detected NRZ sequence;
an ideal RF generator to generate an ideal RF signal based on the synchronized NRZ sequence and the reference level;
a second delay unit to delay the digitized RF signal by a predetermined number of clock cycles;
a subtraction unit to subtract the ideal RF signal from the delayed digitized RF signal;
a third delay unit to delay the synchronized NRZ sequence so as to compensate for a time offset between the output of the subtraction unit and the synchronized NRZ sequence;
a series-parallel conversion unit to convert the delayed synchronized NRZ sequence that is output from the third delay unit into a parallel mode;
a writing strategy parameter memory to store a writing strategy parameter based on output of the series-parallel conversion unit; and
a controller to drive a laser according to the writing strategy parameter stored in the writing parameter memory so as to record data onto an optical storage medium.

17. The recording apparatus of claim 16, further comprising:
an FIR filter to filter the output of the series-parallel conversion unit so as to filter out invalid writing strategy parameters;
wherein the writing strategy parameter memory stores writing strategy parameters based on the output of the FIR filter.

18. The recording apparatus of claim 16, further comprising:
an error processor to generate a feedback error based on the output of the subtraction unit and the output of the series-parallel conversion unit;
a writing strategy feedback error memory to store accumulated feedback errors generated by the error processor, and having at least one cell addressed according to the output of the series parallel conversion unit;
wherein, when the output of the series-parallel conversion unit is a valid writing strategy bit pattern, the output of the series-parallel conversion unit is accumulated in a corresponding cell of the writing strategy feedback error memory, and a corresponding cell in the writing strategy parameter memory is updated based on the contents of the corresponding cell of the writing strategy feedback error memory.

19. The recording apparatus of claim 18, further comprising:
a second error processor to calculate a feedback error based on the detected NRZ sequence; and
wherein the writing strategy feedback error memory stores accumulated feedback errors generated by the second error processor.

20. A recording apparatus comprising:
a Viterbi detector to detect and output a non-return to zero (NRZ) sequence based on a digitized radio frequency (RF) signal and a reference level;
a reference level unit to output the reference level to the Viterbi detector based on the digitized RF signal and the detected NRZ sequence;
an ideal RF generator to generate an ideal RF signal based on the detected NRZ sequence and the reference level;
a first delay unit to delay the digitized RF signal by a predetermined number of clock cycles;
a subtraction unit to subtract the ideal RF signal from the delayed digitized RF signal;
a second delay unit to delay the synchronized NRZ sequence so as to compensate for a time offset between the output of the subtraction unit and the synchronized NRZ sequence;
a series-parallel conversion unit to convert the delayed synchronized NRZ sequence that is output from the third delay unit into a parallel mode;
a writing strategy parameter memory to store a writing strategy parameter based on output of the series-parallel conversion unit; and
a controller to drive a laser according to the writing strategy parameter stored in the writing parameter memory so as to record data onto an optical storage medium.

21. The writing strategy parameters indexing method of claim 1, wherein patterns having a recordable bit that is neither the first recordable bit of a mark or the last recordable bit of the mark are not included.
